(19) United States
(12) Patent Application Publication
(10) Pub. No.: US 2014/0289174 A1
(43) Pub. Date: Sep. 25, 2014

(54) Data Analysis Computer System and Method For Causal Discovery with Experimentation Optimization

(71) Applicants: Alexander Statnikov, New York, NY (US); Konstantinos (Constantin) F. Aliferis, Astoria, NY (US)

(72) Inventors: Alexander Statnikov, New York, NY (US); Konstantinos (Constantin) F. Aliferis, Astoria, NY (US)

(21) Appl. No.: 14/215,877

(22) Filed: Mar. 17, 2014

Related U.S. Application Data
(60) Provisional application No. 61/793,490, filed on Mar. 15, 2013.

(51) Int. Cl. G06N 99/00

(52) U.S. Cl. CPC G06N 99/005
USPC 706/12

(57) ABSTRACT

Discovery of causal models via experimentation is essential in numerous applications fields. One of the primary objectives of the invention is to minimize the use of costly experimental resources while achieving high discovery accuracy. The invention provides new methods and processes to enable accurate discovery of local causal pathways by integrating high-throughput observational data with efficient experimentation strategies. At the core of these methods are computational causal discovery techniques that account for multiplicity (i.e., indistinguishability) of causal pathways consistent with observational data. The invention, when applied for discovery of local causal pathways from a combination of observational and experimental data, achieves higher discovery accuracy than existing observational approaches and uses fewer experimental resources than existing experimental approaches. Repeated application of the invention for each variable in the modeled system produces the full causal model.

Benefit of U.S. Provisional Application No. 61/793,490 filed on Mar. 15, 2013 is hereby claimed.

### BACKGROUND OF THE INVENTION

### Field of Application

The field of application of the invention is data analysis especially as it applies to (so-called) “Big Data” (see sub-section 1 “Big Data and Big Data Analytics” below). The methods, systems and overall technology and knowhow needed to execute data analyses is referred to in the industry by the term data analytics. Data analytics is considered a key competency for modern firms [1]. Modern data analytics technology is ubiquitous (see sub-section 3 below “Specific examples of data analytics application areas”). Data analytics encompasses a multitude of processes, methods and functionality (see sub-section 2 below “Types of data analytics”).

Data analytics cannot be performed effectively by humans alone due to the complexity of the tasks, the susceptibility of the human mind to various cognitive biases, and the volume and complexity of the data itself. Data analytics is especially useful and challenging when dealing with hard data/data analysis problems (which are often described by the term “Big Data”/“Big Data Analytics” (see sub-section 1 “Big Data and Big Data Analytics”).

### 1. Big Data and Big Data Analytics

Big Data Analytics problems are often defined as the ones that involve Big Data Volume, Big Data Velocity, and/or Big Data Variation [2].
Big Data Volume may be due to large numbers of variables, or big numbers of observed instances (objects or units of analysis), or both.
Big Data Velocity may be due to the speed via which data is produced (e.g., real time imaging or sensor data, or online digital content), or the high speed of analysis (e.g., real-time threat detection in defense applications, online fraud detection, digital advertising routing, high frequency trading, etc.).
Big Data Variation refers to datasets and corresponding fields where the data elements, or units of observations can have large variability that makes analysis hard. For example, in medicine one variable (diagnosis) may take thousands of values that can further be organized in interrelated hierarchically organized disease types.

According to another definition, the aspect of data analysis that characterizes Big Data Analytics problems is its overall difficulty relative to current state of the art analytic capabilities. A broader definition of Big Data Analytics problems is thus adopted by some (e.g., the National Institutes of Health (NIH)), to denote all analysis situations that press the boundaries or exceed the capabilities of the current state of the art in analytics systems and technology. According to this definition, “hard” analytics problems are de facto part of Big Data Analytics [3].

### 2. Types of Data Analysis

The main types of data analytics [4] are:
a. Classification for Diagnostic or Attribution Analysis: where a typically computer-implemented system produces a table of assignments of objects into predefined categories on the basis of object characteristics.
   Examples: medical diagnosis; email spam detection; separation of documents as responsive and unresponsive in litigation.
b. Regression for Diagnostic Analysis: where a typically computer-implemented system produces a table of assignments of numerical values to objects on the basis of object characteristics.
   Examples: automated grading of essays; assignment of relevance scores to documents for information retrieval; assignment of probability of fraud to a pending credit card transaction.
c. Classification for Predictive Modeling: where a typically computer-implemented system produces a table of assignments of objects into predefined categories on the basis of object characteristics and where values address future states (i.e., system predicts the future).
   Examples: expected medical outcome after hospitalization; classification of loan applications as risky or not with respect to possible future default; prediction of electoral results,
d. Regression for Predictive Modeling: where a typically computer-implemented system produces a table of assignments of numerical values to objects on the basis of object characteristics and where values address future states (i.e., system predicts the future). Examples: predict stock prices at a future time; predict likelihood for rain tomorrow; predict likelihood for future default on a loan.
e. Explanatory Analysis: where a typically computer-implemented system produces a table of effects of one or more factors on one or more attributes of interest; also producing a catalogue of patterns or rules of influences.
   Examples: analysis of the effects of sociodemographic features on medical service utilization, political party preferences or consumer behavior.
f. Causal Analysis: where a typically computer-implemented system produces a table or graph of causes-effect relationships and corresponding strengths of causal influences describing thus how specific phenomena causally affect a system of interest.
   Example: causal graph models of how gene expression of thousands of genes interact and regulate development of disease or response to treatment; causal graph models of how socioeconomic factors and media exposure affect consumer propensity to buy certain products; systems that optimize the number of experiments needed to understand the causal structure of a system and manipulate it to desired states.
g. Network Science Analysis: where a typically computer-implemented system produces a table or graph description of how entities in a mg system inter-relate and define higher level properties of the system.
   Example: network analysis of social networks that describes how persons interrelate and can detect who is married to whom; network analysis of airports that reveal how the airport system has points of vulnerability (i.e., hubs) that are responsible for the adaptive properties of the airport transportation system (e.g., ability to keep the system running by rerouting flights in case of an airport closure).
h. Feature selection, dimensionality reduction and data compression: where a typically computer-implemented system selects and then eliminates all variables that are irrelevant or redundant to a classification/regression, or explanatory or causal modeling (feature selection) task; or where such as system reduces a large number of variables to a small number of transformed variables that are necessary and sufficient for classification/regression, or explanatory or causal modeling (dimensionality reduction or data compression).
   Example: in order to perform web classification into family-friendly ones or not, web site contents are first cleared of all words or content that is not necessary for the desired classification.
i. Subtype and data structure discovery: where analysis seeks to organize objects into groups with similar characteristics or discover other structure in the data.
   Example: clustering of merchandize such that items grouped together are typically being bought together; grouping of customers into marketing segments with uniform buying behaviors.
j. Feature construction: where a typically computer-implemented system pre-processes and transforms variables in ways that enable the other goals of analysis. Such pre-processing may be grouping, abstracting, existing features or constructing new features that represent higher order relationships, interactions etc.
   Example: when analyzing hospital data for predicting and explaining high-cost patients, co-morbidity variables are grouped in order to reduce the number of categories from thousands to a few dozen which then facilitates the main (predictive) analysis; in algorithmic trading, extracting trends out of individual time-stamped variables and replacing the original variables with trend information facilitates prediction of future stock prices.
k. Data and analysis parallelization, chunking, and distribution: where a typically computer-implemented system performs a variety of analyses (e.g., predictive modeling, diagnosis, causal analysis) using federated databases, parallel computer systems, and modularizes analysis in small manageable pieces, and assembles results into a coherent analysis.
   Example: in a global analysis of human capital retention a world-wide conglomerate with 2,000 personnel databases in 50 countries across 1,000 subsidiaries, can obtain predictive models for retention applicable across the enterprise without having to create one big database for analysis.

### 3. Specific Examples of Data Analytics Application Areas

The following Listing provides examples of some of the major fields of application for the invented system specifically, and Data Analytics more broadly [5]:
1. Credit risk/Creditworthiness predication.
2. Credit card and general fraud detection,
3. Intention and threat detection.
4. Sentiment analysis.
5. Information retrieval, filtering, ranking, and search.
6. Email ail spam detection.
7. Network intrusion detection.
8. Web site classification and filtering.
9. Matchmaking.
10. Predict success of movies.
11. Police and national security applications
12. Predict outcomes of elections.
13. Predict prices or trends of stock markets.
14. Recommend purchases.
15. Online advertising.
16. Human Capital/Resources: recruitment, retention, task selection, compensation.
17. Research and Development.
18. Financial Performance.
19. Product and Service Quality.
20. Client management (selection, loyalty, service)
21. Product and service pricing.
22. Evaluate and predict academic performance and impact.
23, Litigation: predictive coding, outcome/cost/duration prediction, bias of courts, voire dire.
24. Games (e.g., chess, backgammon, jeopardy).
25. Econometrics analysis.
26. University admissions modeling.
27. Mapping fields of activity.
28. Movie recommendations.
29. Analysis of promotion and tenure strategies,
30. intension detection and lie detection based on fMRI readings.
31. Dynamic Control (e.g., autonomous systems such as vehicles, missiles;

industrial robots; prosthetic limbs).
32. Supply chain management.
33. Optimizing medical outcomes, safety, patient experience, cost, profit margin in healthcare systems.
34. Molecular profiling and sequencing based diagnostics, prognostics, companion drugs and personalized medicine,
35. Medical diagnosis, prognosis and risk assessment
36. Automated grading of essays.
37. Detection of plagiarism.
38. Weather and other physical phenomena forecasting,

With regards to discovery of causal models, it is essential for biological and medical applications, financing, marketing, business operations optimization and in many other fields. Causal models provide information not only about what are the mechanisms for observed phenomena but also predict what will be the effects of manipulations of the system modeled. Causal models also allow inferences about what variables need be manipulated and in what ways in order for the modeled system to function in desired ways.

Causal models can be created using purely experimental, purely observational and hybrid experimental-inductive methods and processes. Observational methods are very efficient because they do not require experiments, however they fail to model the system completely. Experimental processes are extremely expensive because they require up to an exponential number of experiments and they are driven by human heuristic strategies. Hybrid methods attempt to derive complete causal models but with as small a number of experiments as possible.

An example application field where the invention applies and was thoroughly tested in is discovering pathways that implicate complex diseases in humans, an activity that is at the forefront of modern biomedical research. Many scientists are specifically interested in discovery of local causal pathways that contain only direct causes and direct effects of the phenotype or target molecule of interest. The present invention consists of new methods to enable accurate discovery of local causal pathways by integrating high-throughput observational data with efficient experimentation strategies. The usefulness of the present invention is demonstrated in empirical comparison with state-of-the-art methods for discovery of local causal pathways from gene expression data. By piecing together such local pathways, more complex pathways (of arbitrary depth) can readily be obtained.

The invention can be applied to practically any field where discovery of causal or predictive models is desired however because it relies on extremely broad distributional assumptions that are valid in numerous fields. Because the discovery of causal models facilitates feature selection, model conversion and explanation, inference and practically all aspects of data analytics, the invention is applicable and useful all the above-mentioned types of data analysis and application areas.

### Description of Related Art

Currently there are two broad classes of state-of-the-art methods and systems for pathway discovery that incorporate experimental data. The first class uses formal semantics and theory of causal graphical models to learn underlying pathways from a combination of observational and experimental data. A notable advance is due to Cooper and Yoo who proposed Bayesian methods for learning causal structure from a combination of observational and experimental data [6-8] and a related system (GEEVE) that uses the above causal discovery techniques together with the expected value of experimentation method to recommend microarray experiments to discover gene-regulation pathways [9-11]. Other important developments include methods for active learning for structure with causal graphical models [12-20]. The second class of methods and systems does not use causal graphical models and emphasizes techniques from automated experimentation, artificial intelligence, systems biology and other disciplines [21-32].

The invented methodologies belong to the first class (that uses causal graphical models to learn pathways from observational and experimental data). The major innovation of the new methodologies is explicit modeling of causal pathway multiplicity that makes assumptions of computational causal discovery methods compatible with real data and in turn improves discovery accuracy. Another innovative aspect of the novel methods is experimentally efficient discovery strategy (in terms of number and types of experiments and required sample size per experiment). Also, our methods do not aim to learn an entire regulatory network or pathway at first pass, compared to the majority of existing techniques, but rather focus on discovery of a local causal pathway that is specific for the response variable of interest (e.g., phenotype, molecule, etc.) and contains only its direct causes and direct effects. This contributes to scalability of the new methodology to high-throughput datasets with hundreds of thousands of variables and more. By repeated application of the local pathway discovery one can obtain the full causal network if one is needed.

### BRIEF DESCRIPTION OF THE FIGURES

FIG. 1 describes the new method ODLP*.

FIG. 2 shows a graphical representation of an example causal network around a phenotypic response variable T. Genes are shown with white circles, and edges represent direct causal influences (modulation/regulation).

FIG. 3 describes the new method ODLP1. Notice that even though the method outputs the local causal pathway of T, during its execution it also discovers the causal role of other variables that will provide additional clues to biologists about underlying mechanisms. Steps 4, 6.c, 10.c provide an interface of the method with the external world through experiments that are conducted by a biologist/experimentalist according to the method's “instructions”, and are shown with dark grey highlighting.

FIG. 4 shows a graphical representation of an example causal network around a phenotypic response variable T. Genes (variables) are shown with circles, and edges represent direct causal influences (modulation/regulation). Genes that are surrounded in the shaded area contain the same amount of information about the phenotype. There are 1,620 predictively equivalent signatures of the phenotype that contain 5 genes (one of each shaded area). Only 54 (3.33%) of them contain genes that are all causes or effects of T, and the remaining 1,566 signatures contain at least one “passenger” gene that is neither cause or effect of T (e.g., X₆). The local causal pathway of T (the set of its direct causes and effects) contains genes X₁, X₇, X₁₂, X₁₈, X₂₁. Current causal pathway discovery methods may erroneously determine that a gene like X₁ does not belong to the local causal pathway because this gene becomes statistically independent of T when conditioned on another information equivalent gene like X₆. This leads to false negative (X₁) and false positive (X₆) predictions in the output of such methods. In this example, current discovery methods will determine the local causal pathway correctly only with probability 1/1620 (˜6.2·10⁻⁴) because other 1619/1620 molecular signatures are likely to be statistically indistinguishable from observational data alone. TIE* method, on the other hand, will identify all 1620 signatures, and the union of genes that participate in all signatures (genes X₁, . . . , X₂₃) will contain 5 true local causal pathway members. The set of these 23 genes can be considered a “draft” of the local causal pathway of the phenotype.

FIG. 5 shows characteristics of 11 local causal pathways and related datasets used for empirical comparison of methods.

FIG. 6 shows results of empirical comparison of the new method ODLP1 and other methods. ODLP1 is denoted by a star.

FIG. 7 shows the organization of a general-purpose modern digital computer system such as the ones used for the typical implementation of the invention.

### DETAILED DESCRIPTION OF THE INVENTION

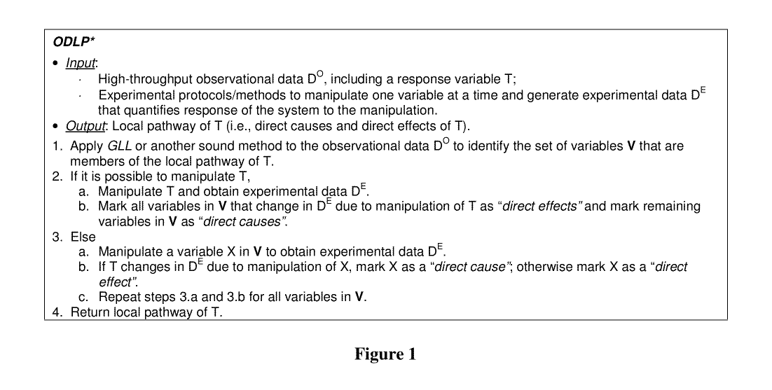

In order to facilitate comprehension of the new methodology, we will first address a simplified problem of local causal pathway discovery, without taking into consideration the redundancy of biological or other causal networks. The new method ODLP* is shown in FIG. 1 (“ODLP” is an acronym for “Optimal Discovery of Local Pathways”). This method is sound and complete under the sufficient assumptions of (i) adjacency faithfulness; (ii) causal Markov condition; (iii) causal sufficiency; (iv) acyclicity of the data-generative graph; and (v) correctness of statistical decisions [33, 34]. The proof of correctness relies on a previously established theoretical result showing that GLL method can identify all members of the local pathway (direct causes and direct effects of the response variable) from observational data under the above stated assumptions [35]. This theoretical result is substantiated by the empirical work demonstrating excellent results of GLL for pathway discovery and scalability to high-throughput data [35-37]. In principle ODLP* can work with another sound method for identification of local causal pathway members in step 1. Notice however, that methods for identification of local pathway members (such as GLL) do not differentiate between direct causes and direct effects in the local pathway, and in general this task has to be accomplished with additional experimental data, as outlined in steps 2 and 3 of ODLP*. The experimental strategy of ODLP* is efficient because it relies only on single-variable manipulation experiments that are expected to generate a small number of samples in order to assess univariate association of the manipulated variable with all other variables. Furthermore, the method tries to minimize the number of single-variable manipulation experiments and will conduct only 1 experiment if T can be manipulated (step 2.a). If it is not possible to manipulate T (e.g., T is a disease in humans), it will conduct the same number of experiments as the number of variables in the output of GLL (set V). In the most general case, it is impossible to further minimize this number of experiments because every variable in V can potentially be a direct cause of T and has to be confirmed by an experiment. However, there are a few exceptions that can lead to savings in experiments (e.g., when X, a direct effect of T, is causing Y, another direct effect of T, then manipulation of X would also reveal that Y is an effect of T and save an experiment) and we do check for them in the method, although they are not mentioned in the method description in order to help understanding its basic principles.

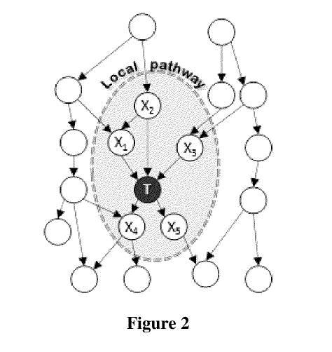

Consider running the ODLP* method on observational data generated from the causal graph shown in FIG. 2. The method aims at identification of the local pathway of the phenotypic response variable T. In step 1 of ODLP*, GLL will identify that genes X₁, X₂, X₃, X₄, X₅ belong to the local pathway of T, however would not discover causal role of any of these genes. If it is possible to manipulate T, we would do so (step 2.a) and reveal that X₄, X₅ change due to manipulation of T, and thus are direct effects of T (step 2.b); the remaining genes X₁, X₂, X₃ therefore have to be direct causes of T (step 2.b). On the other hand, if T cannot be manipulated, we can manipulate X₁ (step 3.a) and observe that T changes due to manipulation of X₁ (step 3.b); therefore X₁ is a direct cause of T (step 3.b). If we consider manipulating X₄ (step 3.a), we would observe that T does not change due to manipulation of X₄ (step 3.b); therefore X₄ is a direct effect of T (step 3.b). When steps 3.a and 3.b are applied to other genes in the local pathway, we will also find two additional direct causes of T (X₂, X₃) and one additional direct effect (X₅) of T.

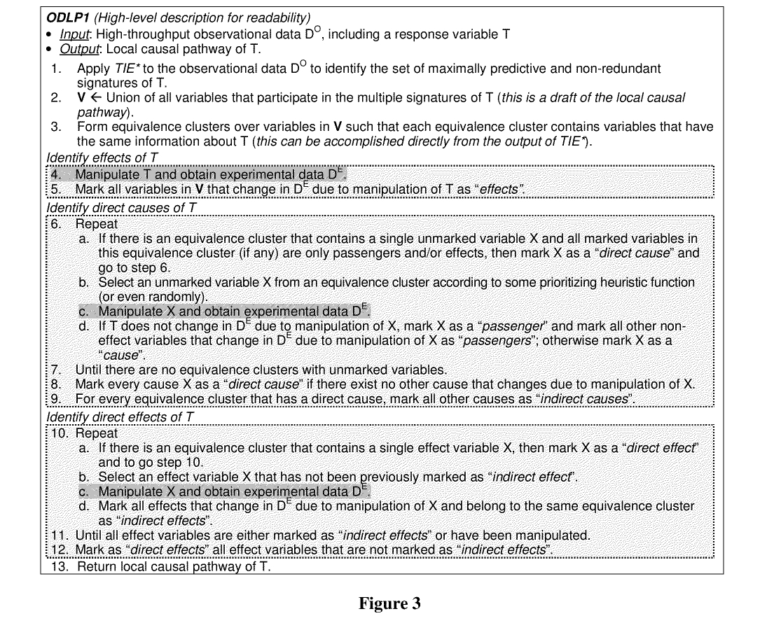

We now describe general methods for identification of local causal pathways that take into consideration redundancy of biological or other types of causal networks. The first method ODLP1 is designed for situations when the response variable can be manipulated; see FIG. 3. ODLP1 is sound under the following common causal discovery sufficient assumptions: (i) adjacency faithfulness relaxed to allow for multiplicity of data-consistent causal pathways [38-40]; (ii) causal Markov condition; (iii) causal sufficiency; and (iv) correctness of statistical decisions [33, 35]. In non-technical terms, the first two assumptions mean that with the exception of empirical information equivalency relations, there is a direct correspondence between data and a directed acyclic data-generative graph in terms of statistical relations (specifically, there is an edge between two variables if and only if they have association in the data conditioned on every subset of other variables). The third assumption means that every common cause of two or more measured variables is also measured in the dataset. The fourth assumption means that determination of variable (in) dependence in the population from the available data sample is correct. We emphasize that these are only sufficient assumptions, and the essential components of the ODLP1 method are robust to violations of the above assumptions [35, 37]. The proof of soundness of ODLP1 follows from the causal Markov condition and a previously established theoretical result showing that TIE* can identify all maximally predictive and non-redundant molecular signatures/pathways of the phenotype and thus “draft” the local causal pathway under the above assumptions [38, 41].

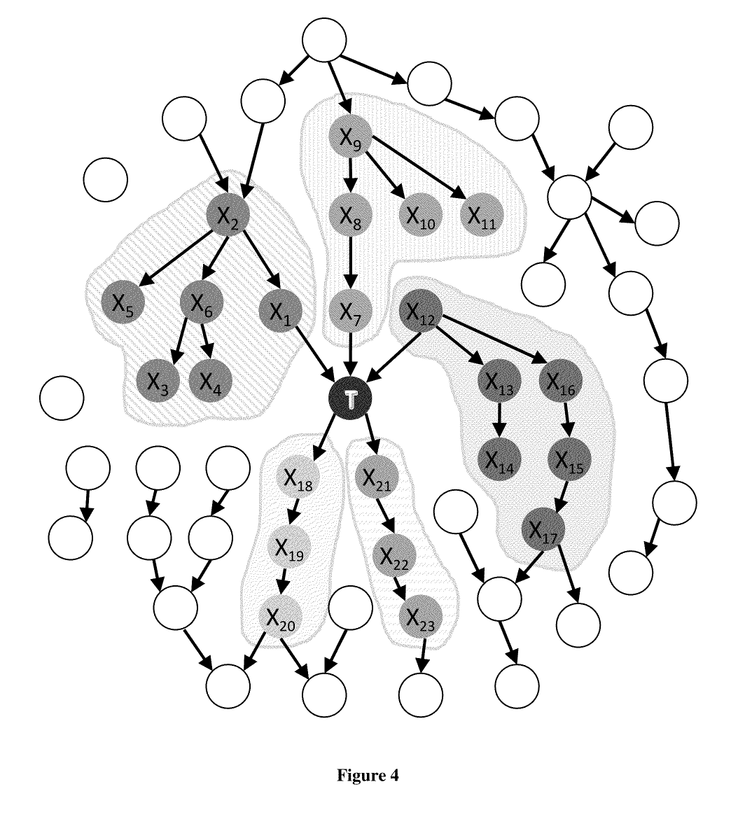

The strategy of ODLP1 relies on single-variable manipulation experiments and requires a small number of samples from each experiment to assess univariate associations of the manipulated variable with other variables. In general, the number of experiments necessary for identification of the local causal pathway depends on the structure of the local causal pathway. In any case, the number of experiments would be manageable because |V|, in typical high-throughput datasets, is between 10 and 200 variables, as we have observed by running TIE* in >30 datasets [38, 41-43]. The main principle behind minimization of experiments is to manipulate first passengers of T that are causing many other passengers of T (recall that “passenger” is neither a cause nor an effect of T and that passengers are connected to T via one or more paths; in the majority of distributions passengers are associated with T). For example, manipulation of X₆ in FIG. 4 would lead to changes in X₃, X₄ but not in T. Therefore, X₃, X₄, X₆ are not causes of T. We can also infer from manipulation of T that X₃, X₄, X₆ do not change and thus are not effects of T. Therefore, they are passengers. We have determined the causal role of X₃, X₄, X₆ by manipulating only one of these genes. However, in many real-life applications we do not know the graphical structure when we perform experiments, and thus we typically need to resort to heuristics to manipulate first variables that are likely to yield savings in experiments. To this end, we used a partial network-based heuristic that chooses a variable that has the highest topological order relative to T. The topological order can be established from constraints learned from experimental data. In addition to the above heuristic, other heuristic functions can be used.

Under fairly restrictive distributional and/or structural assumptions (that are unknown if they hold in all data of interest), it is possible to facilitate cause-effect identification and further reduce the number of experiments by applying to the observational data either constraint-based partial local orientation [44] or newer methods for causal orientation of pairs of variables [45-50] without compromising scalability of the method by requiring to learn the causal graph over all variables [33]. In order to further reduce the number of experiments, we can also consider methods that estimate algorithmic (Kolmogorov) complexity of causal relations within the equivalence cluster, and we have already identified results showing feasibility of this approach [51]. Finally, it is also worthwhile to point out that the ODLP1 method can incorporate background knowledge both on the stages of drafting the local causal pathway (step 1) and determining the causal role of variables (steps 4-12), which can potentially lead to further reducing the number of required experiments.

Consider running ODLP1 on data generated from the network in FIG. 4. The method aims to identify the local causal pathway of the response variable T. In step 1, TIE* will find 1,620 signatures of T. The union of these signatures (set V) will be genes X₁, . . . , X₂₃ (step 2). Then in step 3 ODLP1 will form 5 equivalence clusters of genes based on information that they provide about the T (the clustering will coincide with the grouping of genes in shaded areas in FIG. 4). In steps 4 and 5 the method will manipulate T and identify its effects X₁₈, . . . , X₂₃. Then the method will proceed to identification of causes of T in the candidate set of variables X₁, . . . , X₁₇. There is no equivalence cluster that satisfies criterion of step 6.a, so ODLP1 will proceed to step 6.b and select a variable for manipulation (say, X₆) in step 6.c. The method will then identify that X₆ is a passenger and so are X₃, X₄ (step 6.d). Steps 6.a-6.d will be repeated until the causal role of every non-effect variable is deciphered. Next, the method will conclude that X₁, X₇, X₁₂ are direct causes of T (step 8) and other causes of T (X₂, X₈, X₉) are indirect (step 9). Then ODLP1 will proceed to the identification of direct effects of T in the set of effects (X₁₈, . . . , X₂₃). There is no equivalence cluster that satisfies criterion of step 10.a, so the method will proceed to step 10.b and select a variable for manipulation (say, X₁₉) in step 10.c. In step 10.d ODLP1 will identify that X₂₀ is an indirect effect of T and repeat iterations until all effects are either marked as “indirect effects” (X₁₉, X₂₀, X₂₂, X₂₃) or have been manipulated (X₁₈, X₂₁). In step 12, ODLP1 will conclude that X₁₈, X₂₁ are direct effects of T. Thus the local causal pathway of T (that consists of direct causes X₁, X₇, X₁₂ and direct effects X₁₈, X₂₁) has been identified correctly.

Another novel method ODLP2 allows to discover the local causal pathway of the response variable T even when T cannot be manipulated. ODLP2 follows similar principles as the ODLP1 method. The main difference is that identification of the effects cannot be performed as in steps 4 and 5 of ODLP1 (because we cannot manipulate T). Therefore, ODLP2 first identifies all causes of T and then identifies effects of T through knowledge gained by manipulation of its direct causes. The latter is facilitated by the constraints on causal relations within each equivalence cluster that follow directly from the causal Markov condition and other fundamental assumptions of the method. The average efficiency of the ODLP2 method is potentially worse than the one of ODLP1, however in the worst case both methods need the same number of experiments that is bounded by the number of variables in the output of TIE*.

Finally, another novel method ODLP-LLC applies TIE* or GLL (depending on consideration of redundancy) to the observational data D^{O} to identify the set of maximally predictive and non-redundant signatures of T and then performs experimentation and causal orientation using LLC methods from [16, 17, 52], which are run only on the variables output by TIE* or GLL, plus the response variable.

In what follows we describe evaluation of ODLP1 and state-of-the-art methodological approaches for causal discovery of pathways from observational and experimental data. We use several classes of methods to compare to ODLPJ:
Adaptive Learning of Causal Bayesian Networks (denoted as “ALCBN”) [19];
Active Learning of Causal Networks with Intervention Experiments and Optimal Designs (denoted as “HE-GENG”) [20];
Causal Discovery of Linear Cyclic Models with Latent Variables (denoted as “LLC”) [16, 17, 52];
BIOLEARN [12, 3].
   Specifically, we use 12 variants of ALCBN, 12 variants of HE-GENG, 32 variants of LLC, and 2 variants in 2. Each variant has different parameterizations of the method.

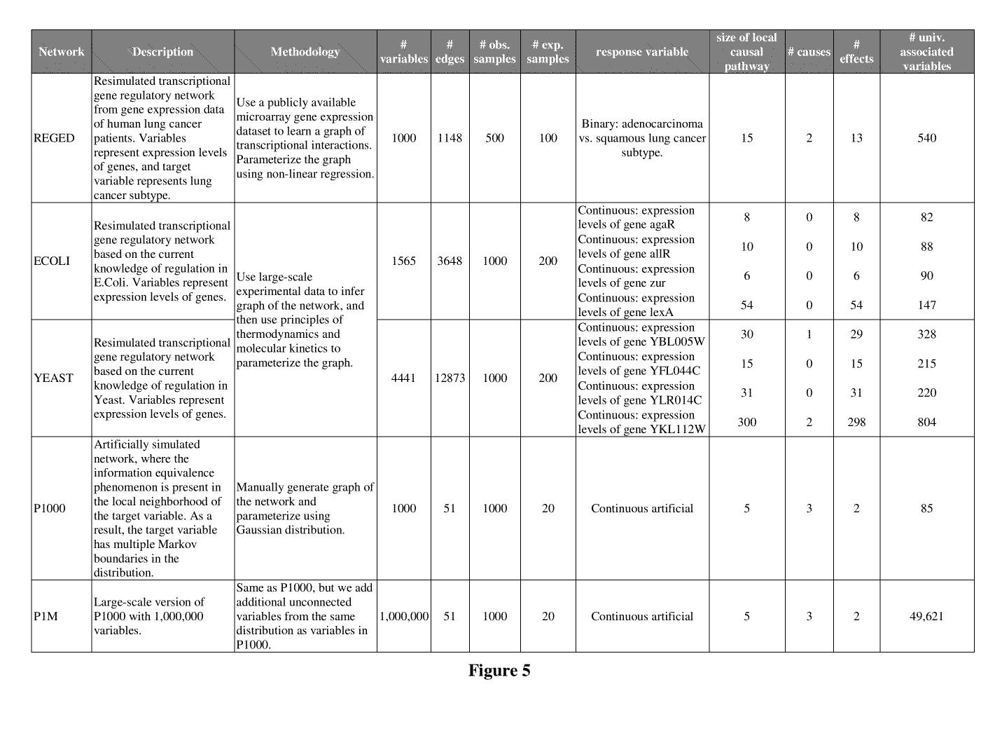

We used resimulated gene expression data that closely follows distribution of real gene expression data and characteristics of real-world transcriptional regulatory networks. Details are given in FIG. 5. In summary, we considered learning 11 local causal pathways from datasets with 1,000-1,000,000 variables/genes by using observational data and in-silico experiments.

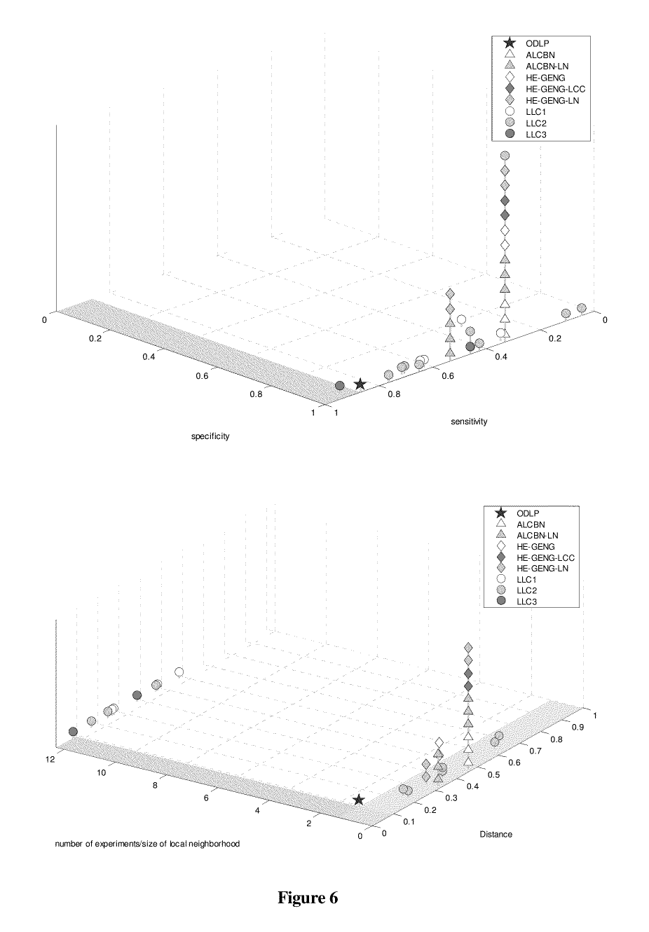

The results of experiments (on average over datasets) are shown in FIG. 6. The methods are evaluated in terms of sensitivity, specificity, and distance (square root of the sum of (1-spensitivity)² and (1-specificity)) for discovery of local causal pathways as well as number of single-variable manipulation experiments divided by the number of variables in the local causal pathway (denoted as “local neighborhood” in FIG. 6). All things being equal, we desire to maximize sensitivity and specificity and minimize distance and number of experiments. As can be seen, there is no method that outperforms ODLP1 in terms of sensitivity and specificity while performing fewer experiments.

In addition to the above experiments in resimulated gene expression data, we have partially applied ODLP1 to real data from two studies involving fatty liver disease and locally advanced breast cancer.

For the study of locally advanced breast cancer (LABC), this analysis involved a preliminary dataset that measured expression of 667 miRNAs using qRT/PCR for 22 non-metastasizing LABCs and 20 metastasized ones. Recall that the ODLP1 method first drafts a disease local causal pathway from the observational data using TIE* (FIG. 3). Application of TIE* to this dataset resulted in at least 20 different molecular signatures of LABC metastasis that involved on average 8 miRNAs; thus indicating the multiplicity of data-consistent causal pathways for this disease. In general many more different molecular signatures (hundreds to thousands) could be extracted from this data, however its small sample size restricted power of signature discovery and the method output only the most statistically reliable signatures. Each of these output signatures can predict metastasis with an area under ROC curve=0.93-0.94, as estimated by cross-validation[53] with the SVM method [54]. The union of miRNAs that participate in all molecular signatures of the phenotype contains 15 miRNAs, most of which are not previously known to be involved in the pathogenesis of breast cancer. These miRNAs can be readily used for experiments with lentiviruses in cell culture or animal models according to experimental strategy of ODLPJ.

For the study of fatty liver disease, we used a large-sample microarray gene expression dataset to draft a local causal pathway of SREBP1 for the experiments that will be suggested by ODLP1. The dataset was obtained from GEO under accession number “GSE11338” [55, 56] and consists of 302 livers from male and female mice. Application of TIE* to this dataset resulted in 8,568 different molecular signatures of SREBP1 with 136 gene probes on average; thus indicating multiplicity of data-consistent causal pathways around SREBP1 in fatty liver disease. Each of these molecular signatures explains 83% of variance in the expression of SREBP1, as estimated by cross-validation[53] with either lasso or kernel ridge regression [57]. There are 239 genes in the union of identified molecular signatures, and this gene set constitutes a “draft” of the local causal pathway of SREBP1. Genes in this set include previously known direct downstream targets of SREBP1 (e.g., Acly, Aph1a, Atf3, Bhlhe40, Bysl, Casp3, Eif2b4, Fasn, Insig1, Pygl, Ralyl, Tcea3, Tmem17, Tmem48, Utp14b) according to a recent ChIP-seq study [58] as well as other prior studies [59-61].

### ABBREVIATIONS

ALCBN—Active Learning of Causal Bayesian Networks (causal discovery method);
BIOLEARN—Bayesian search-and-score causal discovery method;
ChIP-seq—Chromatin Immuno-Precipitation with Sequencing (method to analyze protein interactions with DNA);
GEEVE—Causal discovery in Gene Expression data using Expected Value of Experimentation (causal discovery system);
GEO—Gene Expression Omnibus (database repository of gene expression data);
GLL—Generalized Local Learning (method for local causal pathway discovery);
HE-GENG—Method by He and Geng for active learning of causal Bayesian networks (causal discovery method);
LABC—Locally Advanced Breast Cancer (subtype of breast cancer);
LLC—Linear Latent and Cyclic models (causal discovery methods);
miRNA—Micro RNA (a small non-coding RNA molecule);
ODLP*—Optimal Discovery of Local Pathways, implementation without taking into consideration redundancy of biological networks (causal discovery method);
ODLP1—Optimal Discovery of Local Pathways, implementation with taking into consideration redundancy of biological networks, for situations when the response/target variable T can be manipulated experimentally (causal discovery method);
ODLP2—Optimal Discovery of Local Pathways, implementation with taking into consideration redundancy of biological networks, for situations when the response/target variable T cannot be manipulated experimentally (causal discovery method);
ODLP-LLC—Optimal Discovery of Local Pathways by integrating with Linear Latent Cyclic (LLC) method (causal discovery method);
qRT/PCR—Quantitative Real-Time Polymerase Chain Reaction (measurement technique in molecular biology used to study gene expression);
ROC—Receiver Operating Characteristic (classifier performance curve in the space of 1-specificity vs. sensitivity);
SREBP1—Sterol Regulatory Element-Binding Transcription Factor 1 (protein);
SVM—Support Vector Machines (classification method);
TIE*—Target Information Equivalency (multiple Markov boundary discovery method that is used to find all local causal pathways that are statistically indistinguishable from the data).

Method and System Output, Presentation, Storage, and Transmittance

The relationships, correlations, and significance (thereof) discovered by application of the method of this invention may be output as graphic displays (multidimensional as required), probability plots, linkage/pathway maps, data tables, and other methods as are well known to those skilled in the art. For instance, the structured data stream of the method's output can be routed to a number of presentation, data/format conversion, data storage, and analysis devices including but not limited to the following: (a) electronic graphical displays such as CRT, LED, Plasma, and LCD screens capable of displaying text and images; (b) printed graphs, maps, plots, and reports produced by printer devices and printer control software; (c) electronic data files stored and manipulated in a general purpose digital computer or other device with data storage and/or processing capabilities; (d) digital or analog network connections capable of transmitting data; (e) electronic databases and file systems. The data output is transmitted or stored after data conversion and formatting steps appropriate for the receiving device have been executed.

### Software and Hardware Implementation

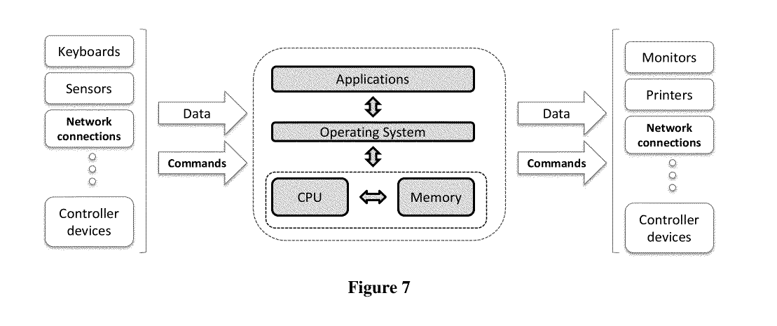

Due to large numbers of data elements in the datasets, which the present invention is designed to analyze, the invention is best practiced by means of a general purpose digital computer with suitable software programming (i.e., hardware instruction set) (FIG. 7 describes the architecture of modern digital computer systems). Such computer systems are needed to handle the large datasets and to practice the method in realistic time frames. Based on the complete disclosure of the method in this patent document, software code to implement the invention may be written by those reasonably skilled in the software programming arts in any one of several standard programming languages including, but not limited to, C, Java, and Python. In addition, where applicable, appropriate commercially available software programs or routines may be incorporated. The software program may be stored on a computer readable medium and implemented on a single computer system or across a network of parallel or distributed computers linked to work as one. To implement parts of the software code, the inventors have used MathWorks Matlab® and a personal computer with an Intel Xeon CPU 2.4 GHz with 24 GB of RAM and 2 TB hard disk.

### REFERENCES

1. Davenport T H, Harris J G: Competing on analytics: the new science of winning: Harvard Business Press; 2013.
2. Douglas L: The Importance of ‘Big Data’: A Definition. Gartner (June 2012) 2012.
3. NIH Big Data to Knowledge (BD2K) [http://bd2k.nih.gov/about_bd2k.html#bigdata]
4. Provost F, Fawcett T: Data Science for Business: What you need to know about data mining and data-analytic thinking: “O'Reilly Media, Inc.”; 2013.
5. Siegel E: Predictive Analytics: The Power to Predict Who Will Click, Buy, Lie, or Die: John Wiley & Sons; 2013.
6. Cooper G F, Yoo C: Causal Discovery from a Mixture of Experimental and Observational Data. Proceedings of the Fifteenth Conference Annual Conference on Uncertainty in Artificial Intelligence (UAI-99) 1999:116-125.
7. Yoo C, Cooper G F: Discovery of gene-regulation pathways using local causal search. ProcAMIA Symp 2002:914-918.
8. Yoo C, Thorsson V, Cooper G F: Discovery of causal relationships in a gene-regulation pathway from a mixture of experimental and observational DNA microarray data. Proceedings of the 2002 Pacific Symposium on Biocomputing 2002:498-509.
9. Yoo C, Cooper G F: An evaluation of a system that recommends microarray experiments to perform to discover gene-regulation pathways. Artif Intell Med 2004, 31(2):169-182.
10. Yoo C, Cooper G F: A computer-based microarray experiment design-system for gene-regulation pathway discovery. AMIA Annu Symp Proc 2003:733-737.
11. Yoo C, Cooper G F, Schmidt M: A control study to evaluate a computer-based microarray experiment design recommendation system for gene-regulation pathways discovery. J Biomed Inform 2006, 39(2):126-146.
12. Sachs K, Perez O, Pe'er D, Lauffenburger D A, Nolan G P: Causal protein-signaling networks derived from multiparameter single-cell data. Science 2005, 308(5721):523-529.
13. Pe'er D, Regev A, Elidan G, Friedman N: Inferring subnetworks from perturbed expression profiles. Bioinformatics 2001, 17 Suppl 1:S215-S224.
14. Tong S, Koller D: Active learning for structure in Bayesian networks. Proceedings of the Seventeenth International Joint Conference on Artificial Intelligence (IJCAI-2001) 2001, 17:863-869.
15. Murphy K P: Active learning of causal Bayes net structure. In. Technical Report, University of California, Berkeley; 2001.
16. Eberhardt F, Hoyer P O, Scheines R: Combining Experiments to Discover Linear Cyclic Models with Latent Variables. Journal of Machine Learning Research, Workshop and Conference Proceedings (AISTATS 2010) 2010, 9:185-192.
17. Hyttinen A, Eberhardt F, Hoyer P O: Causal discovery for linear cyclic models with latent variables. Proceedings of the 5th European Workshop on Probabilistic Graphical Models (PGM 2010) 2010.
18. Pournara I, Wernisch L: Reconstruction of gene networks using Bayesian learning and manipulation experiments. Bioinformatics 2004, 20(17):2934-2942.
19. Meganck S, Leray P, Manderick B: Learning Causal Bayesian Networks from Observations and Experiments: A Decision Theoretic Approach. Modeling Decisions in Artificial Intelligence, LNCS 2006:58-69.
20. He Y, Geng Z: Active learning of causal networks with intervention experiments and optimal designs. Journal of Machine Learning Research 2008, 9:2523-2547.
21. King R D, Rowland J, Oliver S G, Young M, Aubrey W, Byrne E, Liakata M, Markham M, Pir P, Soldatova L N et al: The automation of science. Science 2009, 324(5923):85-89.
22. Sparkes A, Aubrey W, Byrne E, Clare A, Khan M N, Liakata M, Markham M, Rowland J, Soldatova L N, Whelan K E et al: Towards Robot Scientists for autonomous scientific discovery. Autom Exp 2010, 2:1.
23. King R D, Whelan K E, Jones F M, Reiser P G, Bryant C H, Muggleton S H, Kell D B, Oliver S G: Functional genomic hypothesis generation and experimentation by a robot scientist. Nature 2004, 427(6971):247-252.
24. Wolinsky H: I, scientist. Will robots at the bench leave scientists free to think? EMBO Rep 2007, 8(8):720-722.
25. Demsar J: Statistical Comparisons of Classifiers over Multiple Data Sets. Journal of Machine Learning Research 2006, 7:1-30.
26. Demsar J, Zupan B, Bratko I, Kuspa A, Halter J A, Beck R J, Shaulsky G: GenePath: a computer program for genetic pathway discovery from mutant data. Stud Health Technol Inform 2001, 84(Pt 2):956-959.
27. Juvan P, Demsar J, Shaulsky G, Zupan B: GenePath: from mutations to genetic networks and back. Nucleic Acids Res 2005, 33(Web Server issue):W749-W752.
28. Zupan B, Bratko I, Demsar J, Juvan P, Curk T, Borstnik U, Beck J R, Halter J, Kuspa A, Shaulsky G: GenePath: a system for inference of genetic networks and proposal of genetic experiments. Artif Intell Med 2003, 29(1-2):107-130.
29. Zupan B, Demsar J, Bratko I, Juvan P, Halter J A, Kuspa A, Shaulsky G: GenePath: a system for automated construction of genetic networks from mutant data. Bioinformatics 2003, 19(3):383-389.
30. Ideker T E, Thorsson V, Karp R M: Discovery of regulatory interactions through perturbation: inference and experimental design. Pac Symp Biocomput 2000:305-316.
31. Szczurek E, Gat-Viks I, Tiuryn J, Vingron M: Elucidating regulatory mechanisms downstream of a signaling pathway using informative experiments. Mol Syst Biol 2009, 5:287.
32. Tegner J, Yeung M K, Hasty J, Collins J J: Reverse engineering gene networks: integrating genetic perturbations with dynamical modeling. Proc Natl Acad Sci USA 2003, 100(10):5944-5949.
33. Spirtes P, Glymour C N, Scheines R: Causation, prediction, and search, vol. 2nd. Cambridge, Mass.: MIT Press; 2000.
34. Ramsey J: A PC-style Markov blanket search for high-dimensional datasets. Technical Report, CMU-PHIL-177, Carnegie Mellon University, Department of Philosophy 2006.
35. Aliferis C F, Statnikov A, Tsamardinos I, Mani S, Koutsoukos X D: Local Causal and Markov Blanket Induction for Causal Discovery and Feature Selection for Classification. Part I: Algorithms and Empirical Evaluation. Journal of Machine Learning Research 2010, 11:171-234.
36. Narendra V, Lytkin N I, Aliferis C F, Statnikov A: A comprehensive assessment of methods for de-novo reverse-engineering of genome-scale regulatory networks. Genomics 2011, 97(1):7-18.
37. Aliferis C F, Statnikov A, Tsamardinos I, Mani S, Koutsoukos X D: Local Causal and Markov Blanket Induction for Causal Discovery and Feature Selection for Classification. Part II: Analysis and Extensions. Journal of Machine Learning Research 2010, 11:235-284.
38. Statnikov A: Algorithms for Discovery of Multiple Markov Boundaries:

Application to the Molecular Signature Multiplicity Problem. In.: Ph.D. Thesis, Department of Biomedical Informatics, Vanderbilt University; 2008.
39. Ramsey J, Zhang J, Spirtes P: Adjacency-Faithfulness and Conservative Causal Inference. Proceedings of the 22nd Annual Conference on Uncertainty in Artificial Intelligence (UAI-2006) 2006:401-408.
40. Lemeire J, Meganck S, Cartella F: Robust Independence-Based Causal Structure Learning in Absence of Adjacency Faithfulness. Proceedings of the Fifth European Workshop on Probabilistic Graphical Models (PGM 2010) 2010.
41. Statnikov A, Aliferis C F: Analysis and Computational Dissection of Molecular Signature Multiplicity. PLoS Computational Biology 2010, 6(5):e1000790.
42. Lytkin N I, McVoy L, Weitkamp J H, Aliferis C F, Statnikov A: Expanding the understanding of biases in development of clinical-grade molecular signatures: a case study in acute respiratory viral infections. PLoS One 2011, 6(6):e20662.
43. Alekseyenko A V, Lytkin N I, Ai J, Ding B, Padyukov L, Aliferis C F, Statnikov A: Causal graph-based analysis of genome-wide association data in rheumatoid arthritis. Biology Direct 2011, 6:25.
44. Yin J, Zhou Y, Wang C, He P, Zheng C, Geng Z: Partial orientation and local structural learning of causal networks for prediction. Journal of Machine Learning Research Workshop and Conference Proceedings (WCCI2008 workshop on Causality) 2008, 3:93-105.
45. Peters J, Janzing D, Sch″lkopf B: Identifying Cause and Effect on Discrete Data using Additive Noise Models. Journal of Machine Learning Research, Workshop and Conference Proceedings (AISTATS 2010) 2010, 9:597-604.
46. Daniusis P, Janzing D, Mooij J, Zscheischler J, Steudel B, Zhang K, Schölkopf B: Inferring deterministic causal relations. Proceedings of the 26th Conference on Uncertainty in Artificial Intelligence (UAI-2010) 2010:143-150.
47. Hoyer P O, Janzing D, Mooij J, Peters J, Scholkopf B: Nonlinear causal discovery with additive noise models. Advances in Neural Information Processing Systems 2009, 21:689-696.
48. Janzing D, Sun X, Sch″lkopf B: Distinguishing Cause and Effect via Second Order Exponential Models. In.: arXiv:0910.5561v1 [stat.ML]; 2009.
49. Zhang K, Hyvärinen A: Distinguishing causes from effects using nonlinear acyclic causal models. Journal of Machine Learning Research, Workshop and Conference Proceedings (NIPS 2008 causality workshop) 2008, 6:157-164.
50. Statnikov A, Henaff M, Lytkin N I, Aliferis C F: New Methods for Separating Causes from Effects in Genomics Data. (In press) BMC Genomics 2012.
51. Lemeire J, Meganck S, Cartella F, Liu T, Statnikov A: Inferring the causal decomposition under the presence of deterministic relations. Proceedings of the 19th European Symposium on Artificial Neural Networks (ESANN 2011) 2011.
52. Hyttinen A, Eberhardt F, Hoyer P O: Learning linear cyclic causal models with latent variables. Journal of Machine Learning Research 2012, 13:3387-3439.
53. Weiss S M, Kulikowski C A: Computer systems that learn: classification and prediction methods from statistics, neural nets, machine learning, and expert systems. San Mateo, Calif.: M. Kaufmann Publishers; 1991.
54. Vapnik V N: Statistical learning theory. New York: Wiley; 1998.
55. Orozco L D, Cokus S J, Ghazalpour A, Ingram-Drake L, Wang S, van NA, Che N, Araujo J A, Pellegrini M, Lusis A J: Copy number variation influences gene expression and metabolic traits in mice. Hum Mol Genet 2009, 18(21):4118-4129.
56. Farber C R, van NA, Ghazalpour A, Aten J E, Doss S, Sos B, Schadt E E, Ingram-Drake L, Davis R C, Horvath S et al: An integrative genetics approach to identify candidate genes regulating BMD: combining linkage, gene expression, and association. J Bone Miner Res 2009, 24(1):105-116.
57. Hastie T, Tibshirani R, Friedman J H: The elements of statistical learning: data mining, inference, and prediction. New York: Springer; 2001.
58. Seo Y K, Chong H K, Infante A M, Im S S, Xie X, Osborne T F: Genome-wide analysis of SREBP-1 binding in mouse liver chromatin reveals a preference for promoter proximal binding to a new motif. Proc Natl Acad Sci USA 2009, 106(33):13765-13769.
59. Brown M S, Goldstein J L: A proteolytic pathway that controls the cholesterol content of membranes, cells, and blood. Proc Natl Acad Sci USA 1999, 96(20):11041-11048.
60. Osborne T F: Sterol regulatory element-binding proteins (SREBPs): key regulators of nutritional homeostasis and insulin action. J Biol Chem 2000, 275(42):32379-32382.
61. Shimano H, Horton J D, Shimomura I, Hammer R E, Brown M S, Goldstein J L: Isoform 1c of sterol regulatory element binding protein is less active than isoform 1a in livers of transgenic mice and in cultured cells. J Clin Invest 1997, 99(5):846-854.

We claim:

1. A computer-implemented method and system for optimizing experimental manipulations for discovery of local causal pathways comprising the following steps:
1) applying Generalized Local Learning or another sound method to a dataset to create from the analysis dataset, a list of variables V that are members of the local causal pathway of the response variable T;
2) if the response variable T can be experimentally manipulated,
a. experimentally manipulating T and obtaining experimental data, in other words providing post-manipulation measurements of all variables in V;
b. marking all variables in the set V that change in the experimental data due to manipulation of T as “direct effects” and marking remaining variables in V as “direct causes”;
3) if the response variable T cannot be experimentally manipulated, repeating the following for all variables X in the set V;
a. experimentally manipulating X and obtaining experimental data;
b. if T changes in the experimental data due to manipulation of X, marking X as a “direct cause” and if T does not change marking X as “direct effect”; and
4) outputting the local causal pathway of T by identifying the causal role of each variable as either having a direct effect or a direct cause in the pathway.

2. The computer-implemented method and system of claim 2, where instead of steps 2-3 all variables in the set V are experimentally manipulated and their causal roles are deciphered from the resulting experimental data, following the principle that if a variable X is changing in the experimental data obtained by manipulating Y, then X is an effect of Y and Y is a cause of X.

3. A computer-implemented method and system for optimizing experimental manipulations for discovery of local causal pathways comprising the following steps:
1) applying TIE*, iTIE* or another sound method to a dataset to create from the analysis dataset, a list of candidate local causal pathway members sets of a response variable T such that each member set is statistically indistinguishable from any of the other sets using only data;
2) creating a list of variables that consists of the union of all variables that participate in the above determined pathways and denoting this list by V;
3) forming a catalogue of variable lists with each list named an “equivalence cluster” from the variables in V such that each equivalence cluster contains variables that have the same information about T;
4) creating a list of effects of T by:
a. experimentally manipulating T and obtaining experimental data;
b. marking all variables in the set V that change in the experimental data due to manipulation of T as “effects”;
5) creating a list of direct causes of T by:
a. repeating the following four sub-steps until there are no equivalence clusters with unmarked variables:
i. if there is an equivalence cluster that contains a single unmarked variable X and all marked variables in this equivalence cluster (if any) are marked only as “passengers” and/or effects, then marking X as a “direct cause” and repeating this sub-step 5.a.i;
ii. selecting an unmarked variable X from an equivalence cluster according to a user-provided prioritizing heuristic function or randomly;
iii. experimentally manipulating X and obtaining experimental data;
iv. if T does not change in the experimental data due to manipulation of X, then marking X as a “passenger” and marking all other non-effect variables that change in experimental data due to manipulation of X as “passengers” and, if T does change in the experimental data due to manipulation of X, marking X as a “cause”;
b. marking every cause of X as a “direct cause” if there exist no other cause that changes due to manipulation of X;
c. for every equivalence cluster that has a direct cause marking all other causes as “indirect causes”;
6) creating a list of direct effects of T by:
a. repeating the following four sub-steps until all effect variables are either marked as “indirect effects” or have been manipulated;
i. if there is an equivalence cluster that contains a single effect variable X, then marking X as a “direct effect” and repeating this sub-step 6.a.i;
ii. selecting an effect variable X that has not been previously marked as “indirect effect”;
iii. manipulating X and obtaining experimental data;
iv. marking all effects that change in the experimental data due to manipulation of X and belong to the same equivalence cluster as “indirect effects”;
b. marking as “direct effects” all effect variables that are not marked as “indirect effects”; and
7) outputting the local causal pathway of T by identifying the causal role of each variable as either having a direct effect or a direct cause in the pathway.

4. The computer-implemented method and system of claim 3 adapted for situations when T cannot be manipulated, where the method first identifies all causes of T and then identifies effects of T through knowledge gained by manipulation of its direct causes.

5. The computer-implemented method and system of claim 3, where instead of steps 4-6 all variables in the list V are manipulated and their causal roles are deciphered from the resulting experimental data, following the principle that if a variable X is changing in the experimental data obtained by manipulating Y, then X is an effect of Y and Y is a cause of X.

6. A computer-implemented method and system for optimizing experimental manipulations for discovery of local causal pathways comprising the following steps:
1) applying TIE*, iTIE* or another sound method to a dataset to create from the analysis dataset, a list of candidate local causal pathway members sets of a response variable T such that each member set is statistically indistinguishable from any of the other sets using only data;
2) creating a list of variables that consists of the union of all variables that participate in the above determined pathways and denoting this list by V;
3) performing experimental manipulation of selected variables in V and reconstruct the causal network around T using the LLC methods and variants run on the union of variables in V and T; and
4) outputting the local causal pathway of T by identifying the causal role of each variable as either having a direct effect, direct cause passenger, indirect effect, and indirect cause in the pathway.

7. The computer-implemented method and system of claim 6, where all variables in V are manipulated in step 3.
